(19) United States
(12) Patent Application Publication
(10) Pub. No.: US 2004/0052611 A1
(43) Pub. Date: Mar. 18, 2004

(54) Heat sink fastener

(75) Inventor: Ke-Pin Liu, Taipei Hsien (TW)

Correspondence Address: BACON & THOMAS, PLLC, 625 SLATERS LANE, FOURTH FLOOR, ALEXANDRIA, VA, 22314

(73) Assignee: TAI-SOL ELECTRONICS CO., LTD., Taipei Hsien (TW)

(21) Appl. No.: 10/322,529

(22) Filed: Dec. 19, 2002

(30) Foreign Application Priority Data
Sep. 16, 2002 (TW) 91214556

(51) Int. Cl. F16B 19/00

(52) U.S. Cl. 411/508

(57) ABSTRACT

A heat sink fastener is constructed to include a barbed bolt for insertion into a mounting hole of a heat sink and a corresponding mounting hole of a circuit board to hold down the heat sink on a processor chip at the circuit board, and a springy cushion sleeved onto the bolt and adapted to support the head of the barbed bolt above the heat sink and to offset biasing force from the heat sink after installation of the barbed bolt in the heat sink and the circuit board.

### BACKGROUND OF THE INVENTION

1. Field of the Invention

The present invention relates to heat sinks for dissipating heat from a semiconductor device, for example, a computer processor chip, and more particularly, to a fastener for fastening a heat sink.

2. Description of the Related Art

FIG. 1 shows a heat sink fastener according to the prior art. This structure of heat sink fastener 90 comprises a bolt 91, a coiled spring member 92, and a C-shaped retainer 95. The bolt 91 has an annular groove 93 around the periphery near the end for receiving the C-shaped retainer 95. As shown in FIG. 2, when in use, the bolt 91 is inserted through the spring member 92 and then the corresponding holes 99 of the heat sink 97 and the circuit board 98, and then the C-shaped retainer 95 is fastened to the annular groove 93 of the bolt 91 to secure the bolt 91 to the heat sink 97 and the circuit board 98, keeping the spring 92 supported between the head of the bolt 91 and the top side of heat sink 97.

This structure of heat sink fastener 90 has drawbacks as follows:

1. Unstable pressure: Because the coiled spring member must have a certain number of turns so as to provide a linear spring power, the fastener requires much vertical installation space. When designed for use in a limited space, for example, inside a notebook computer, the number of turns of the coiled spring member is limited, resulting in insufficient linear spring power and unstable pressure to the heat sink.

2. Applicable to chips having the heat emitting point at the center: As shown in FIG. 3, when used to hold down the heat sink 97 on a processor chip 89 having a protruded heat emitting side, the aforesaid prior art fastener cannot keep the heat sink 97 in horizontal, resulting in poor heat dissipation effect. Therefore, the aforesaid prior art fastener can only be used to hold down a heat sink on a processor chip having its heat emitting point at the center area.

### SUMMARY OF THE INVENTION

The present invention has been accomplished under the circumstances in view. It is one object of the present invention to provide a heat sink fastener, which provides a stable holding down pressure to the heat sink.

It is another object of the present invention to provide a heat sink fastener, which is practical for use to hold down a heat sink on any of a variety of computer chips.

To achieve these objects of the present invention, the heat sink fastener comprises a bolt for insertion into a mounting hole of a heat sink and a corresponding mounting hole of a circuit board to hold down a heat sink on a processor chip at the circuit board, and a springy cushion having a center through hole for receiving said bolt and a top surface contacted to a bottom surface of a head of the bolt. Wherein the top surface of the springy and the bottom surface of the head of the bolt are flat. The bolt has a positioning structure, which enables the bolt to be inserted into the mounting hole of the heat sink and the mounting hole of the circuit board and, prohibits the bolt from backward movement after insertion into the mounting hole of the heat sink and the mounting hole of the circuit board.

### BRIEF DESCRIPTION OF THE DRAWINGS

FIG. 1 is an exploded view of a heat sink fastener according to the prior art.

FIG. 2 illustrates an application example of the prior art heat sink fastener.

FIG. 3 illustrates the heat sink tilted on the protruded top heat emitting side of a processor chip according to the prior art.

FIG. 4 is an exploded view of a heat sink fastener according to the present invention.

FIG. 5 is an assembly view of the heat sink fastener according to the present invention.

FIG. 6 is a schematic drawing showing an application example of the present invention.

FIG. 7 is a sectional view showing the heat sink fastener fastened to a heat sink and a circuit board according to the present invention.

FIG. 8 shows two alternate forms of the bolt for the heat sink fastener according to the present invention wherein one bolt has a polygonal head, and the other bolt has a round head.

FIG. 9 shows still another alternate form of the bolt for the heat sink fastener according to the present invention.

FIG. 10 shows still another alternate form of the bolt for the heat sink fastener according to the present invention.

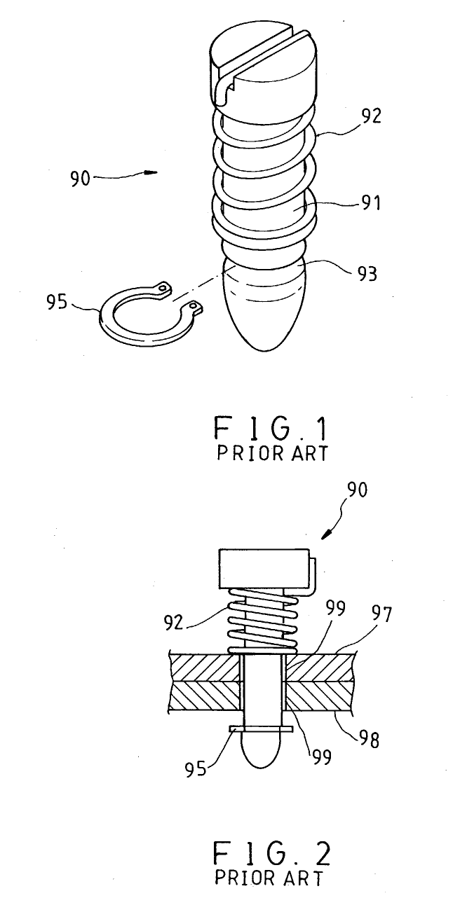

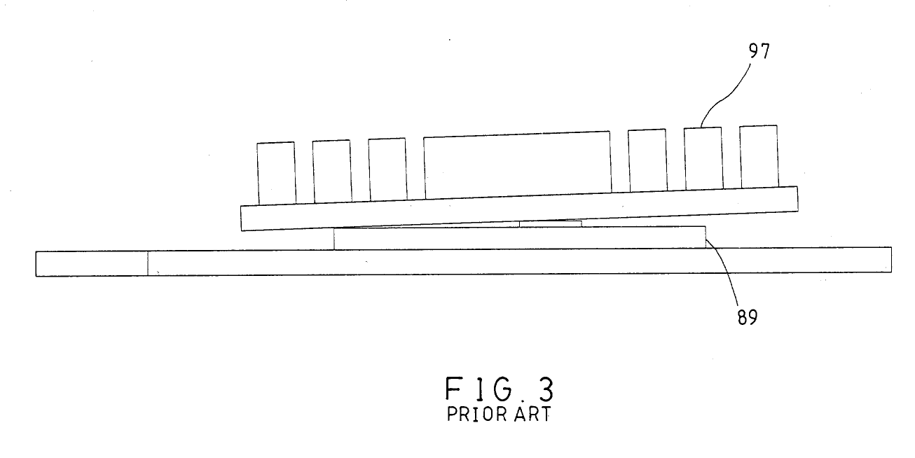

### DETAILED DESCRIPTION OF THE INVENTION

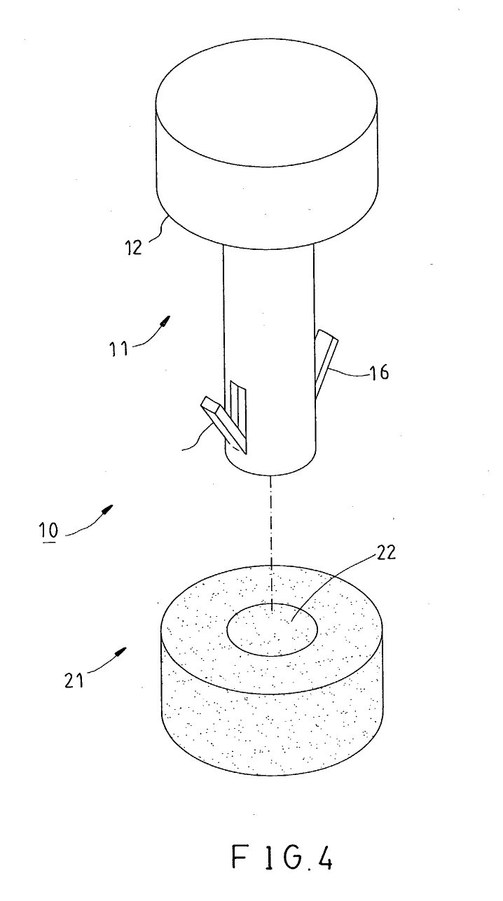

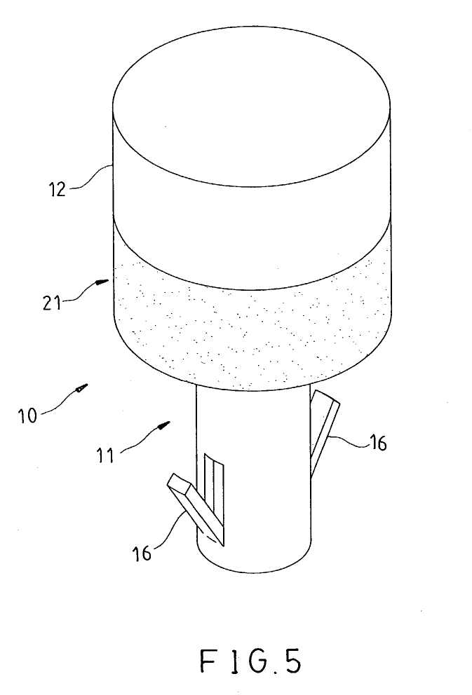

Referring to FIGS. 4 and 5, a heat sink fastener 10 is shown comprised of a bolt 11 and a springy cushion 21.

The bolt 11 has an expanded head 12 at one end (of the shank thereof) and a positioning structure 16 at the other end (of the shank) remote from the head 12. According to this embodiment, the head 12 has a flat, circular shape. The positioning structure 16 is formed of two barbs symmetrically disposed at two sides (of the shank).

The springy cushion 21 is a short cylindrical springy block made of silicon rubber, having a center through hole 22. By means of the center through hole 22, the springy cushion 21 is sleeved onto the (shank of the) bolt 12, keeping the flat top surface of the springy cushion 21 attached to the flat bottom surface of the expanded head 12 of the bolt 11.

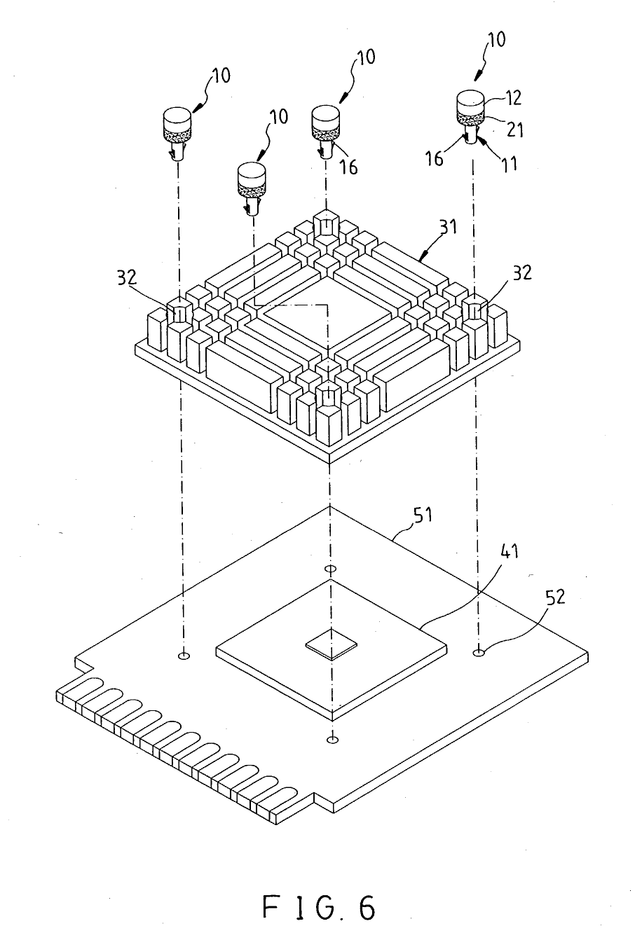

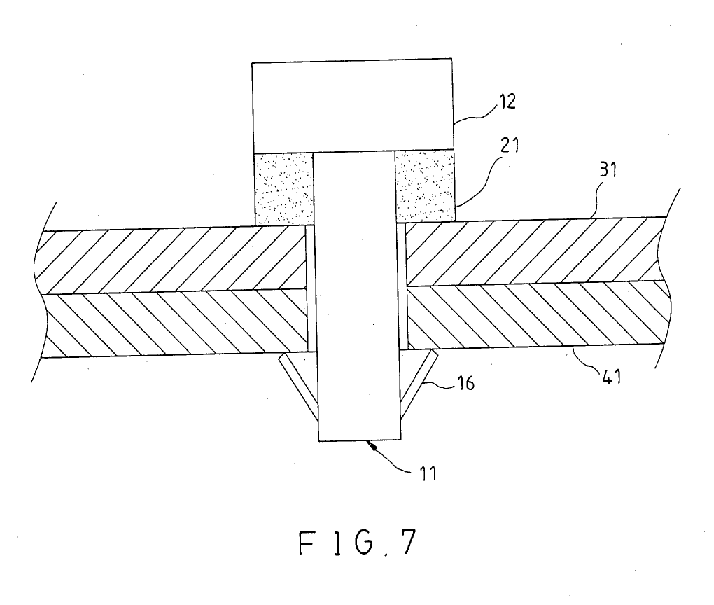

Referring to FIGS. 6 and 7, four heat sink fasteners 10 are respectively installed in the four mounting holes 32 of the heat sink 31 and the corresponding mounting holes 52 of the circuit board 51 to hold down the head sink 31 on the processor chip 41 at the circuit board 51 in balance. When inserting the bolt 11 of one heat sink fastener 10 through one mounting hole 32 of the heat sink 31 and the corresponding mounting hole 52 of the circuit board 51, the positioning structure (the barbs) 16 is compressed inwards, for enabling the bolt 11 to pass. When passed, the positioning structure (the barbs) 16 immediately returns to its former shape and stopped at the bottom sidewall of the circuit board 41, and at the same time the expanded head 12 is pressed on the springy cushion 21 against the top sidewall of the heat sink 31, and therefore the heat sink 31 is positively held down in balance on the processor chip 41.

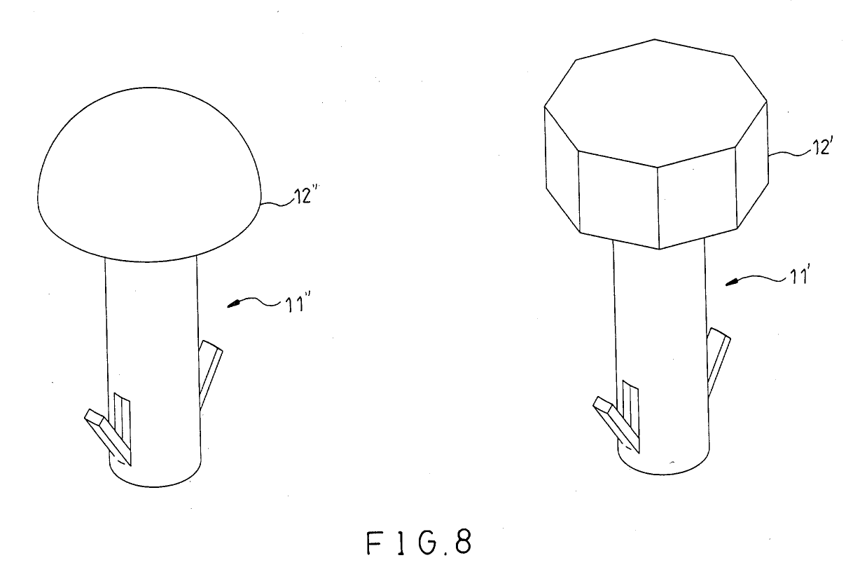

The expanded head 12 of the bolt 11 may be variously shaped. FIG. 8 shows two alternate forms of the bolt. The bolt 11′ at the right side in FIG. 8 has a polygonal head 12′. The bolt 11″ at the left side in FIG. 8 has a round head 12″ of semispherical shape.

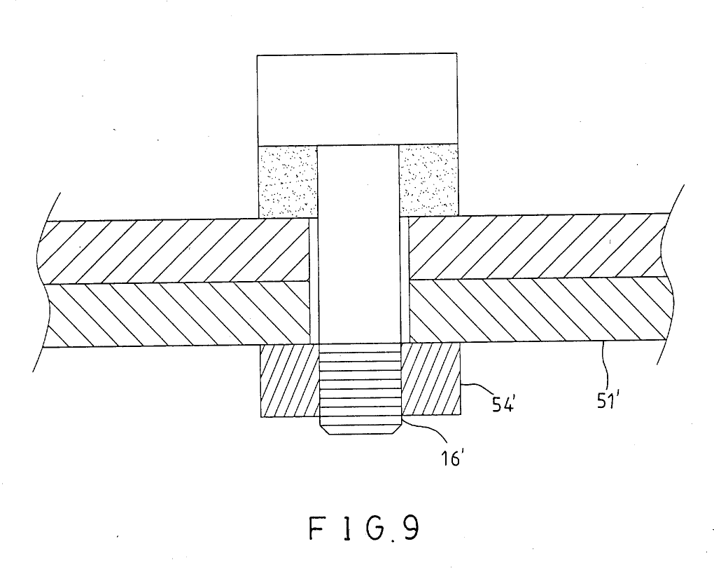

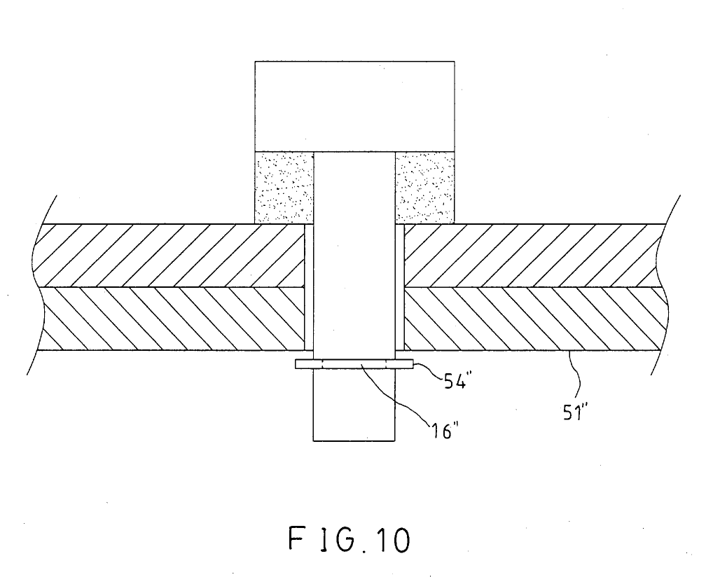

FIG. 9 shows still another alternate form of the bolt. According to this embodiment, the positioning structure 16′ is formed of an outer thread extended around the shank of the bolt onto which a lock nut 54′ is threaded and stopped at the bottom side of the circuit board 51′.

FIG. 10 shows still another alternate form of the bolt. According to this alternate form, the positioning structure 16″ is an annular groove extended around the periphery of the shank to which a C-shaped retainer 54″ is fastened and stopped at the bottom side of the circuit board 51″.

As indicated above, the heat sink fastener of the present invention has the following advantages:

1. Ensured pressure: Because the cushion 21 is made of silicon rubber, it provides a springy holding-down effect. Further, because the cushion 21 is a flat member, it provides effective linear spring power within a short stroke. Because the pressure produced by the cushion 21 can be well controlled, the cushion 21 is superior to a coiled spring member.

2. Applicable to processor chips that emit heat eccentrically: When the heat sink fastener used to fix a heat sink to a circuit board and to hold down the heat sink on a processor chip at the circuit board that has a protruded top heat emitting side, the cushion offsets biasing force from the heat sink, keeping the heat sink in balance and in close contact with the protruded top heat emitting side of the processor chip for quick dissipation of heat from the processor chip.

What is claimed is:

1. A heat sink fastener comprising:
a bolt having an expanded head at one end thereof and a positioning structure at an opposite end thereof; and
a springy having a center through hole for receiving said bolt and a top surface contacted to a bottom surface of the head of the bolt; wherein said top surface of the springy and said bottom surface of the head of the bolt are flat.

2. The heat sink fastener as defined in claim 1, wherein said head of said bolt has a flat top surface and the flat bottom surface.

3. The heat sink fastener as defined in claim 2, wherein said head of said bolt has a flat circular shape.

4. The heat sink fastener as defined in claim 1, wherein said head of said bolt has a polygonal shape.

5. The heat sink fastener as defined in claim 1, wherein said head of said bolt is a round head having a semispherical shape.

6. The heat sink fastener as defined in claim 1, wherein said positioning structure of said bolt comprises at least one barb.

7. The head sink fastener as defined in claim 1, wherein said positioning structure of said bolt comprises an outer thread extended around the periphery of said bolt, and a lock nut for threading onto said outer thread.

8. The heat sink fastener as defined in claim 1, wherein said positioning structure of said bolt comprises an annular groove extended around the periphery of said bolt, and a C-shaped retainer for fastening to said annular groove.

9. The heat sink fastener as defined in claim 1, wherein said springy cushion is a flat member.

10. The heat sink fastener as defined in claim 1, wherein said springy cushion is made of silicon rubber.
